(19) United States
(12) Patent Application Publication
(10) Pub. No.: US 2016/0153513 A1
(43) Pub. Date: Jun. 2, 2016

(54) AIR SPRING BELLOWS INCLUDING RENEWABLE RESOURCES

(71) Applicant: Firestone Industrial Products Co., LLC, Indianapolis, IN (US)

(72) Inventor: Jason Nieten, Noblesville, IN (US)

(73) Assignee: Firestone Industrial Products Co., LLC, Indianapolis, IN (US)

(21) Appl. No.: 14/037,529

(22) Filed: Sep. 26, 2013

Related U.S. Application Data
(60) Provisional application No. 61/706,308, filed on Sep. 27, 2012.

(51) Int. Cl. F16F 9/04; B60G 11/27

(52) U.S. Cl. CPC F16F 9/0409; B60G 11/27

(57) ABSTRACT

An air spring having an airsleeve having a plurality of layers, where at least one layer of said airsleeve includes a rubber component that comprises a renewable filler.

### FIELD OF THE INVENTION

Embodiments of the present invention are directed toward compositions for air spring bellows that comprise a renewable resource as a filler.

### BACKGROUND OF THE INVENTION

Air springs, or pneumatic suspension devices, have long been used to isolate road disturbances from a vehicle, seat, or cab. An air spring, as part of a vehicle's suspension, supports the vehicle's load or mass at each axle. Typically, each axle of a vehicle associated with an air spring supports the mass component or load carried by the axle. In addition, there may be ancillary air springs that support driver comfort in and around the driver's compartment, or cab. In an air spring, a volume of gas, usually air, is confined within a flexible container. As an air spring is compressed (jounce travel), the pressure of the gas within the air spring increases; and as an air spring extends (rebound travel), the pressure of the gas within the air spring decreases. Road disturbances are mainly absorbed by this compression and extension of the air springs as a function of work (w=∫F·dx). Air springs are often engineered to have a specific spring rate or spring constant, thereby controlling jounce and rebound characteristics for the desired application and for comfort.

Because an air spring may undergo countless cycles between compression and extension, the air spring must include an enclosure container for the gas that is flexible and durable. Typically, these enclosures are referred to as bellows or airsleeves and are made of cord-(fabric or metal) reinforced rubber compositions. Cord-fabric may be, but is not limited to, natural or synthetic materials.

Fillers for use in air spring compositions generally include carbon black, clay, and limestone. Carbon black, clay, and limestone are considered to be non-renewable resources, which are materials that cannot be reproduced, grown, or regenerated on a scale that can sustain its consumption rate. Non-renewable resources include natural materials that are consumed much faster than nature can create them. In contrast, the supply of renewable resources such as agricultural products, can be restored within a shortened timeframe. Examples of renewable resources include agricultural products. Products derived from corn are examples of renewable resources. Because they can be restored more quickly, renewable resources are believed to be friendlier to the environment than non-renewable resources.

Therefore, a need exists in the air spring art for air spring compositions that comprise renewable resources.

### DESCRIPTION OF THE DRAWINGS

FIG. 1 is a perspective view of an exemplary air spring according to one or more embodiments of the present invention.

FIG. 2 is a perspective view of an exemplary air spring according to one or more embodiments of the present invention.

FIG. 3 is a perspective view of an exemplary air spring according to one or more embodiments of the present invention.

FIG. 4 is a cutaway view of an exemplary airsleeve showing its layered construction.

### DETAILED DESCRIPTION OF ILLUSTRATIVE EMBODIMENTS

Embodiments of the present invention are based upon the discovery that technologically useful air bellows can be manufactured from rubber compositions that include a renewal resource as a filler. It is contemplated that renewable fillers can provide air bellows with an overall comparable or improved balance of properties as air springs that do not contain a renewable filler.

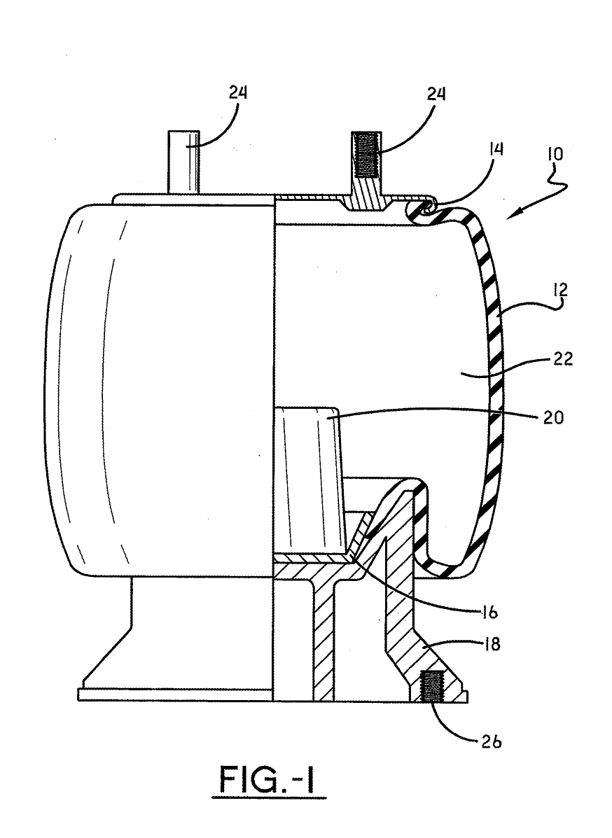

The figures show various embodiments of air springs. In FIG. 1, an air spring assembly is designated generally by the numeral 10. The air spring assembly 10 includes flexible airsleeve 12, which may also be referred as bellow 12. Bead plate 14 is crimped to airsleeve 12 to form an airtight seal between bead plate 14 and airsleeve 12. Similarly, end closure 16 is molded to flexible airsleeve 12 to form an airtight seal between end closure 16 and airsleeve 12. End closure 16 of airsleeve 12 is affixed to piston 18 by mechanical means well known in the art, including, for example, a piston bolt (not shown). Piston 18 provides a surface for flexible airsleeve 12 to roll on during compressive (jounce) travel. Flexible air spring assembly 10 may optionally include bumper 20 to support the vehicle when there is no air in the air springs or during extreme road disturbances. Enclosed within airsleeve 12 is a volume of gas 22. Studs 24 and hole 26 are used to secure the flexible air spring assembly 10 to the mounting surface of an automobile (not shown).

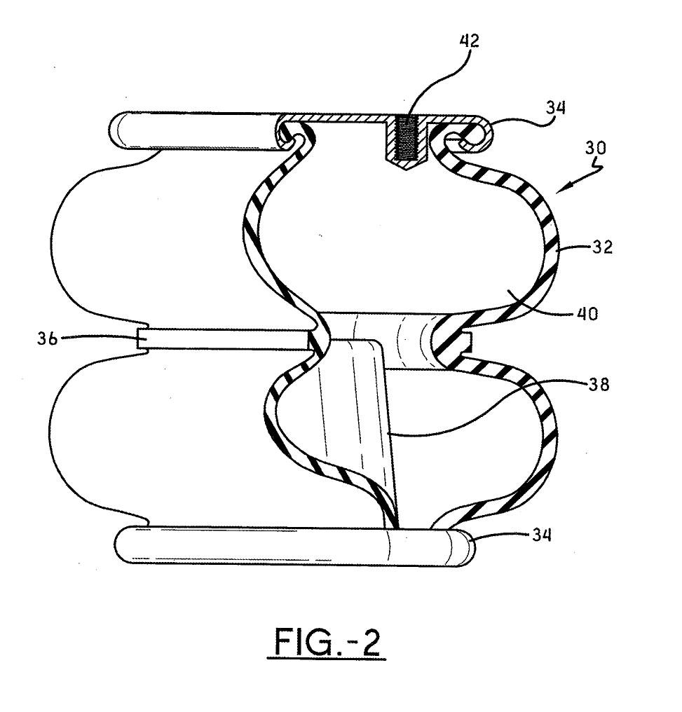

FIG. 2 shows an exemplary (double) convoluted air spring assembly designated generally by the numeral 30. Convoluted air spring assembly 30 includes flexible airsleeve 32. Bead plates 34 are crimped to airsleeve 32 to form an airtight seal between bead plates 34 and airsleeve 32. A girdle hoop 36 is affixed to airsleeve 32 between bead plates 34. Convoluted air spring assembly 30 may optionally include bumper 38 to support the vehicle when there is no air in the air springs or during extreme road disturbances. Enclosed within airsleeve 32 is a volume of gas 40. Blind nuts, including 42 and other blind nuts (not shown), are used to secure the convoluted air spring assembly 30 to the mounting surface of an automobile (not shown).

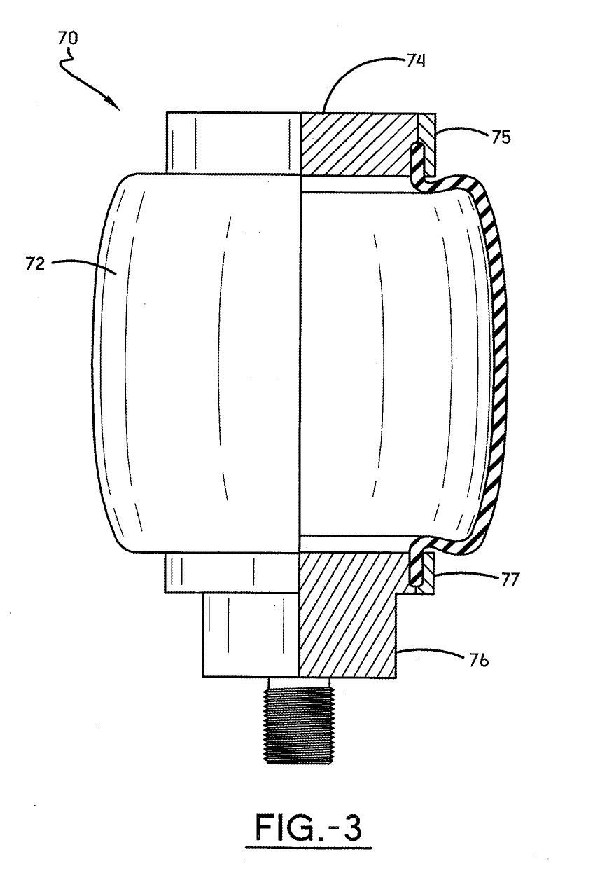

FIG. 3 shows an exemplary cab/seat spring assembly designated generally by the numeral 70. Cab/seat spring assembly 70 includes flexible air sleeve 72. Cab/seat plate 74 is attached to air sleeve 72 to form an air tight seal there between by using, for example, metal ring 75. An airtight seal can be made using known techniques such as those described in U.S. Pat. No. 6,474,630, which is incorporated herein by reference. Suspension plate 76 is likewise secured to airsleeve 72 via metal ring 77 to form an airtight seal there between.

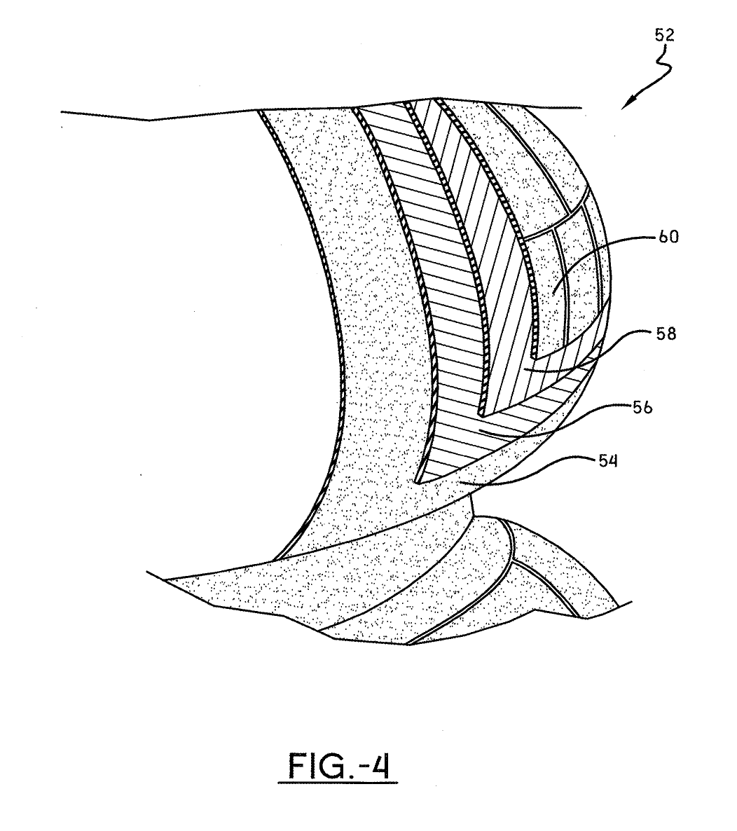

In one or more embodiments, airsleeves 12, 32, and 72 are made of cord-(fabric or metal) reinforced rubber and may be comprised of several layers, as shown in a cutaway view of an exemplary airsleeve 52 in FIG. 4. Exemplary airsleeve 52 features “two-ply” construction and includes four layers including: innerliner 54, first ply 56, second ply 58, and outer cover 60. Innerliner 54 and outer cover 60 may include calendared rubber. As shown, first ply 56 may include a single ply of cord-reinforced rubber with the cords at a specific bias angle, and second ply 58 may include a single ply of fabric-reinforced rubber with the same bias angle laid opposite that of first ply 56. Thus in one or more embodiments, each layer of the airsleeve may contain a rubber component. The rubber component of each layer may be the same or different.

While the present invention is described in the context of an airsleeve and an air spring used in the suspension of an automobile, one of skill in the art will appreciate that the teachings disclosed are general and the present invention may be applied to other art relating to the air spring areas. The other areas might include, for example, air springs for seats, air springs used to support truck cabs, air springs used with buses, and the like.

One or more embodiments of the present invention are directed toward rubber compositions, which may also be referred to as vulcanizable compositions, that are useful in the manufacture of one or more layers of an air spring bellow. In certain embodiments, the rubber composition is used in every layer of the bellow.

In one or more embodiments, the rubber composition is formed from a vulcanizable composition that includes a vulcanizable elastomer, a renewable filler, and a cure system. Other ingredients that may be included in the vulcanizable composition include additional fillers, plasticizers, antioxidants, oils, curatives, and other additives that are conventionally employed in rubber compositions, while at the same time offering potential benefits to the environment.

In one or more embodiments, the elastomer includes those polymers that are capable of being cured (also referred to as vulcanized) to form elastomeric compositions of matter. Elastomers that are useful in vulcanizable compositions for air spring bellows are further described in co-pending U.S. Application Publication No. 2010/0117274 and International Application Publication No. WO 2011/0884488, both of which are incorporated herein by reference in their entirety.

As those skilled in the art appreciate, exemplary polymers include natural rubber, synthetic polyisoprene, polybutadiene, polyisobutylene-co-isoprene, polychloroprene, poly(ethylene-co-propylene), poly(styrene-co-butadiene), poly(styrene-co-isoprene), poly(styrene-co-isoprene-co-butadiene), poly(isoprene-co-butadiene), poly(ethylene-co-propylene-co-diene), polysulfide rubber, acrylic rubber, urethane rubber, nitrile rubber, hydrogenated nitrile rubber, silicone rubber, epichlorohydrin rubber, chlorinated polyethylene and mixtures thereof.

In particular embodiments, the vulcanizable composition includes polymers that derive from the polymerization of halogenated dienes and optionally monomer copolymerizable therewith. An exemplary halogenated diene is 2-chloro-1,3-butadiene, which is also known as chloroprene. Examples of monomer copolymerizable with chloroprene includes sulfur and 2,3-dichloro-1,3-butadiene. Homopolymers of chloroprene are generally referred to as polychloroprene. For purposes of this description, the rubbers deriving from the copolymerization of chloroprene and monomer copolymerizable therewith may be referred to as polychloroprene copolymers.

In one or more embodiments, polychloroprene or polychloroprene copolymers employed in the practice of this invention may be characterized by a Mooney viscosity (ML₁₊₄ at 100° C.) of at least 25, in other embodiments at least 40, in other embodiments at least 60, in other embodiments at least 80, and in other embodiments at least 100. In these or other embodiments, the polychloroprene or polychloroprene copolymers may be characterized by a Mooney viscosity (ML₁₊₄ at 100° C.) of less than 150, in other embodiments less than 130, in other embodiments less than 110 in other embodiments less than 80, in other embodiments less than 60, and in other embodiments less than 50. In particular embodiments, the polychloroprene or polychloroprene copolymers may be characterized by a Mooney viscosity (ML₁₊₄ at 100° C.) of from about 100 to about 120, and in other embodiments from about 41 to about 51.

As described above, the rubber composition includes a renewable material that is useful as a filler.

In one or more embodiments, the renewable filler may be an agricultural product. Suitable agricultural products include corn-based fillers. Examples of corn-based fillers include ground corn, ground corn cobs, and other corn byproducts. Corn-based fillers that are made from corncobs are commercially available from Best Cob LLC (Rock Falls, Ill.).

In one or more embodiments, the average particle size of the renewable filler is at least 0.1 microns, in other embodiments, at least 0.5 microns, in other embodiments, at least 0.7 microns, and in other embodiments, at least 1 micron. In one or more embodiments, the average particle size of the renewable filler is at least 5 microns, in other embodiments, at least 10 microns, and in other embodiments, at least 15 microns. In one or more embodiments, the average particle size of the renewable filler is at least 50 microns, and in other embodiments, at least 200 microns. In one or more embodiments, the average particle size of the renewable filler is less than 500 microns, in other embodiments 200 microns or less, and in other embodiments less than 70 microns. In one or more embodiments, the average particle size of the renewable filler is less than 50 microns, in other embodiments 15 microns or less, and in other embodiments less than 10 microns. In one or more embodiments, the average particle size of the renewable filler is less than 5 microns, in other embodiments less than 1 micron, and in other embodiments less than 0.7 microns.

In one or more embodiments, the rubber composition includes an additional filler. An additional filler, for purposes of this specification, is a filler other than a renewable filler. In one or more embodiments, the vulcanizable composition of this invention may include one or more reinforcing fillers and/or one or more non-reinforcing fillers.

Examples of additional fillers include silicon, carbon black, coal filler, ground recycled rubber, clay, magnesium hydroxide, titanium dioxide, iron oxide, aluminum trihydrate, mica, calcium carbonate, and talc. In other embodiments, the rubber composition may include two or more additional fillers.

In one or more embodiments, the vulcanizable composition of this invention may include carbon black. Carbon black is virtually pure elemental carbon in the form of colloidal particles that are produced by incomplete combustion or thermal decomposition of gaseous or liquid hydrocarbons under controlled conditions. Carbon black may be added to the vulcanizable composition as a reinforcing filler to achieve the required balance of processability, hardness and tensile or tear properties. Generally, any conventional carbon black, or blends of the same, used in compounding rubber-based airsleeve formulations is suitable for use in the present invention.

In one or more embodiments, the vulcanizable composition of this invention may include silica. Useful forms of silica (silicon dioxide) include crystalline and amorphous silica. The crystalline form of silica includes quartz, tridymite and cristobalite. Amorphous silica may occur when the silicon and oxygen atoms are arranged in an irregular form as identified by X-ray diffraction. In one or more embodiments, the silica is a precipitated silica. In these or other embodiments, fumed silica is employed. Commercially available forms of silica are available from PPG Industries, Inc. (Monroeville, Pa.), Degussa Corporation (Parsippany, N.J.) and J.M. Huber Corporation (Atlanta, Ga.). One useful commercial product is Rubbersil® RS-150, which is characterized by a BET surface area of 150 m²/g, tapped density of 230 g/liter, pH (5% in water suspension) of 7, SiO2 content of 98%, Na₂SO₄ content of 2%, and Al₂O₃ content of 0.2%.

In one or more embodiments, the rubber composition may include clay as an additional filler. In other embodiments, the present invention is devoid of clay. Useful clays include hydrated aluminum silicates. In one or more embodiments, useful clays can be represented by the formula Al₂O₃SiO₂.XH₂O. Exemplary forms of clay include kaolinite, montmorillonite, atapulgite, illite, bentonite, halloysite, and mixtures thereof. In one embodiment, the clay is represented by the formula Al₂O₃SiO₂.3H₂O. In another embodiment, the clay is represented by the formula Al₂O₃SiO₂.2H₂O. In a preferred embodiment, the clay has a pH of about 7.0.

In one or more embodiments, various forms or grades of clays may be employed. Exemplary forms or grades of clay include air-floated clays, water-washed clays, calcined clays, and chemically modified (surface treated) clays. In other embodiments, untreated clays may be used.

Air-floated clays include hard and soft clays. In one or more embodiments, hard clays include those characterized as having a lower median particle size distribution, and higher surface area than soft clays. In one or more embodiments, soft clays include those characterized by having a higher median particle size distribution and lower surface area than hard clays. Hard and soft clays are disclosed in U.S. Pat. Nos. 5,468,550, and 5,854,327, which are incorporated herein by reference.

In one embodiment, the air-floated clays used have a pH of from about 4.0 to about 8.0, and in another embodiment, the pH is about neutral. Useful airfloated clays have an average particle size of less than about 2 microns. Typical airfloated clays have a specific gravity of around 2.6 g/cc. Airfloated clays, both hard and soft, are available through various sources.

Water washed clays include those clays that are more closely controlled for particle size by the water fractionation process. This process permits the production of clays within controlled particle size ranges. In one or more embodiments, the average particle size of the clay is less than about 2 microns in diameter. In one embodiment, the water washed kaolin clay includes hydrated aluminum silicate, and may be characterized by a pH of from about 6 to about 7.5, and a specific gravity of about 2.6 g/cc.

Calcined clays include those that result from the removal of water contained in clays (clays typically contain about 14 percent water) by calcination.

Chemically modified (surface treated) clays include those that have cross-linking ability, which can be imparted to the clay by modifying the surface of individual particles with a polyfunctional silane coupling agent. In one or more embodiments, the coupling agents include a silane group or moiety that is believed to react with a hydroxyl group on the filler and chemically bond thereto. Inasmuch as silica includes hydroxyl groups that will react with silane groups on the coupling agent, the coupling agents may be referred to as silica coupling. In other embodiments, the coupling agents may be referred to as silane coupling agents. Useful silica coupling agents are disclosed in U.S. Pat. Nos. 3,842,111, 3,873,489, 3,978,103, 3,997,581, 4,002,594, 5,580,919, 5,583,245, 5,663,396, 5,674,932, 5,684,171, 5,684,172, 5,696,197, 6,608,145, and 6,667,362, the disclosures of which are incorporated herein by reference.

It will be understood that carbon black often acts as a black pigment, and rubber compositions containing a threshold amount of carbon black will be black. In the absence of significant amounts of black filler, the air spring sleeves of the present invention may advantageously be lighter in color. The lighter color of the rubber compositions lends colorability to the air spring sleeves. For example, in embodiments where caron-based filler is employed as a partial or full replacement for carbon black, the air spring sleeve may be lighter in color. Similarly, in embodiments where titanium dioxide is employed as an additional filler, the air spring sleeve may be generally white, due to the ability of the titanium dioxide to function as a white pigment. In embodiments where iron oxide is employed as an additional filler, the air spring sleeve may be generally red, due to the ability of the iron oxide to function as a red pigment.

In one or more embodiments, the vulcanizable composition of this invention includes an additional colorant, such as a dye or pigment. The colorant may enhance the white color of compositions that do not contain black filler, or may provide a color other than black or white to the vulcanizable composition.

In one or more embodiments, at least one layer of the air spring sleeve is a non-black color. In one or more embodiments, the air spring sleeve is a non-black color. In one or more embodiments, the non-black color may be red, blue, green, white, purple, orange, yellow, or any color that can be created through the use of dyes or pigments. In other embodiments, the air spring sleeve may be black. In one or more embodiments, each layer of the air spring sleeve is the same color as the other layers. In particular embodiments, the layers of the air spring sleeve are different colors. In certain embodiments, the outer layer of the air spring sleeve is a non-black color.

In one or more embodiments, the vulcanizable composition of this invention may include an antioxidant. Useful antioxidants include bisphenol type antioxidants, diphenylamines, and zinc salts.

Antidegradants protect the final product vulcanizate against damaging external influences such as oxidation, ozone, heat, and dynamic stresses. Suitable antidegradants include 4- and 5-methyl-2-mercaptobenzimidazole (MMBI), mixed diaryl-p-phenylene type antidegradants, IPPD, or N-isopropyl-N′-phenyl-p-phenylenediamine, and 6PPD, or N-(1,3-dimethylbutyl)-N-phenyl-p-phenylenediamine.

In one or more embodiments, the vulcanizable composition of this invention may include low oil swell factices, or vulcanized oils. In specific embodiments, these compounds include sulfur vulcanized vegetable oils. These factices decrease compound nerve and may permit higher liquid plasticizer levels. Factices may also speed the incorporation of fillers and increase milling efficiency. A suitable factice is commercially available from Akrochem Corporation (Akron, Ohio) under the Akrofax tradename.

In one or more embodiments, plasticizers, which may also be referred to as softeners, include, but are not limited to, fatty acids, vegetable oils, petroleum products, coal tar products, pine products, esters, and resins. In particular embodiments, the plasticizers include esters such as dicapryilphthalate, butylcuminate, dibutylphthalate, butyllactate, glycerol chlorobenzoate, methylricinoleate, octyloleate, dioctylphthalate, or dioctylsebacate

In one or more embodiments, the vulcanizable compositions of this invention may include a tackifier or tackifier resin. As is known in the art, these resins generally increase the tackiness of the composition. Natural or synthetic resins may be employed. In particular embodiments, a nitrile rubber latex is employed as a tackifier. In these or other embodiments, the tackifier may include Koresin (BASF), which is believed to be a resin of acetylene and p-t-butylphenol. Certain embodiments, selection of the tackifier and the amount of tackifier employed advantageously compensates for the lack of tackiness associate with the HNBR, which lack of tackiness would frustrate the processing of the vulcanizable composition and/or the manufacturing of the bellow.

In one or more embodiments, the vulcanizable composition of this invention may include wax. Wax is a processing aid and serves as a release agent.

In one or more embodiments, the vulcanizable composition of this invention may include a low viscosity polyethylene wax. Low viscosity polyethylene wax is a release, or antisticking, agent. A useful low viscosity polyethylene wax is available from Akrochem Corporation (Akron, Ohio) under the PE-100 tradename.

In one or more embodiments, the vulcanizable composition of this invention includes a curative, or cure package. The cure package includes a sulfur-based compound and may also include other optional ingredients. Although one having skill in the art may appreciate other possible cure packages, an exemplary cure package includes sulfur, TMTD, zinc oxide, Vulkanox MB2 (AO2), and IPPD.

Sulfurs that are soluble or insoluble in elastomers may be used. Exemplary sulfur is Crystex OT 20, polymeric sulfur that is insoluble in elastomers. At vulcanization temperatures, Crystex OT 20 de-polymerizes to soluble sulfur and behaves similarly to what is traditionally known as “rubber maker's sulfur” and fosters the crosslinking of polymer molecules. Crystex OT 20 is commercially available from Flexsys (Akron, Ohio).

TMTD, or tetramethylthiuram disulfide, is a cure accelerant that increases the rate of cure by catalyzing the addition of sulfur chains to the rubber molecules. TMTD is commercially available from Western Reserve Chemical Corporation (Stow, Ohio).

Zinc oxide acts as a cure activator in the presence of sulfur, one or more accelerators, and unsaturated rubber to help promote the formation of sulfur cross-links during the vulcanization process.

In one or more embodiments, the vulcanizable composition of this invention may include stearic acid. Stearic acid (octadecanoic acid) is a waxy solid and has the chemical formula C₁₈H₃₆O₂. Stearic acid is particularly effective as a processing aid in minimizing mill and calendar roll sticking.

In one or more embodiments, the vulcanizable composition of this invention may include magnesium oxide (MgO). The primary function of magnesium oxide is to neutralize trace hydrogen chloride that may be liberated by the polymer during processing, vulcanization heat aging or service. By removing the hydrogen chloride, magnesium oxide prevents auto-catalytic decomposition resulting in greater stability. Magnesium oxide may also take part in the crosslinking process.

In one or more embodiments, the vulcanizable compositions employed in practicing the present invention include a sufficient amount of vulcanizable rubber so as to achieve a technologically useful airsleeve of an air spring. In one or more embodiments, the overall vulcanizable composition of matter includes at least 35% by weight, in other embodiments at least 40% by weight, and in other embodiments at least 45% by weight vulcanizable rubber. In these or other embodiments, the overall vulcanizable composition of matter includes less than 99%, in other embodiments less than 90%, and in other embodiments less than 75% by weight vulcanizable rubber. In one or more embodiments, at least 80%, in other embodiments at least 90%, and in other embodiments at least 95% of the rubber component of the vulcanizable composition comprises polychloroprene or polychloroprene copolymers.

In one or more embodiments, the amount of renewable fillers included in the rubber composition may be considered in relation to the amount of additional filler. That is, in one or more embodiments, the total additional filler volume may be reduced by the amount of renewable filler that is present. In one or more embodiments, the total renewable filler volume may be about half, in other embodiments about one third, and in other embodiments about one fourth the volume of the additional filler (e.g. one-half the volume of carbon black, so that the total filler volume includes about two-thirds carbon black and one-third renewable filler, by volume). It should also be appreciated that reference to the level or amount of filler in the vulcanizable composition corresponds to the level or amount of filler in the air sleeve or in the layer of the air sleeve in question.

In other embodiments, the amount of renewable filler may be considered independently of the amount of additional filler. In one or more embodiments, the total amount of the renewable filler used in the production of the rubber composition is less than 50 parts by weight filler per 100 parts by weight rubber, in other embodiments less than 40 pbw phr, in other embodiments less than 30 pbw phr, and in other embodiments less than 15 pbw phr. In one or more embodiments, the total amount of the renewable filler used in the production of the rubber composition is more than 1 pbw phr, in other embodiments more than 5 pbw phr, and in other embodiments more than 10 pbw phr.

In one or more embodiments, the amount of renewable filler may be expressed in terms of the total filler, that is the renewable filler plus the additional filler. In one or more embodiments, the vulcanizable composition may include at least about 20, in other embodiments at least about 30, and in other embodiments at least about 40 pbw filler phr. In one or more embodiments, the vulcanizable composition may include less than about 100, in other embodiments less than about 75, and in other embodiments less than about 50 pbw filler phr. In one or more embodiments, the vulcanizable composition may include less than about −40, in other embodiments less than about 30, and in other embodiments less than about 20 pbw filler phr.

In one or more embodiments, the vulcanizable compositions may include at least 10 parts by weight (pbw), in other embodiments at least 15 pbw, and in other embodiments at least 18 pbw additional filler, based on 100 parts by weight rubber (phr). In these or other embodiments, the vulcanizable compositions may include less than 50 pbw, in other embodiments less than 45 pbw, and in other embodiments, less than 40 pbw additional filler phr. In these or other embodiments, the vulcanizable compositions include from about 10 to about 50, in other embodiments from about 15 to about 45 pbw, and in other embodiments from about 18 to about 40 pbw additional filler, based on 100 parts by weight rubber (phr). It will be understood that parts by weight of the component per 100 parts by weight of the rubber (e.g., elastomeric polymer) can be referred to as phr. It will also be appreciated that reference to the level or amount of additional filler in the vulcanizable composition corresponds to the level or amount of additional filler in the sleeve or in the layer of the sleeve.

In certain embodiments, the vulcanizable composition of this invention is devoid of plasticizer. In one or more embodiments, the vulcanizable compositions may include at least 7 pbw, in other embodiments at least 10 pbw, and in other embodiments at least 12 pbw plasticizer, based on 100 parts by weight rubber (phr). In these or other embodiments, the vulcanizable compositions may include less than 100 pbw, in other embodiments less than 90 pbw, and in other embodiments less than 80 pbw plasticizer phr. In these or other embodiments, the vulcanizable compositions may include from about 0 to about 100 weight %, in other embodiments from about 10 to about 90 pbw, and in other embodiments from about 12 to about 80 pbw plasticizer, based on 100 parts by weight rubber (phr).

In certain embodiments, the vulcanizable composition of this invention is devoid of tackifiers. In certain embodiments, the vulcanizable composition of this invention may include at least 1 part by weight, in other embodiments at least 2 parts by weight, in other embodiments at least 4 parts by weight tackifier phr.

In these or other embodiments, the vulcanizable composition may include less than 10 pbw, in other embodiments less than 8 pbw, in other embodiments less than 5 pbw tackifier phr. In these or other embodiments, the vulcanizable compositions may include from about 0 to about 10 weight %, in other embodiments from about 1 to about 8 tackifier phr.

Those skilled in the art will be able to select an appropriate amount of the various ingredients that can be used based upon the ultimate desired properties sought within the airsleeve of an air spring. Likewise, those skilled in the art will be able to select an appropriate amount of curative and extending cure agents in order to achieve a desired level of cure.

The compositions for preparing one or more layers of airsleeve according to the present invention can be prepared by conventional means using conventional rubber compounding equipment such as Brabender, Banbury, Werner-Pfleiderer, Sigma-blade mixer, two-roll mill, or other mixers suitable for forming viscous, relatively uniform admixtures. Mixing techniques depend on a variety of factors such as the specific types of polymers used, and the fillers, processing oils, waxes, and other ingredients used. In one or more embodiments, the ingredients can be added together in a single stage. In other embodiments, some of the ingredients, such as renewable filler, additional filler, etc., can be first loaded followed by the rubber. In other embodiments, a more conventional manner can be employed where the rubber is added first followed by the other ingredients. In even other embodiments, the rubber may be added at the same time as the renewable filler.

Mixing cycles generally range from about 2 to 10 minutes. In certain embodiments an incremental procedure can be used whereby the rubber and part of the ingredients are added first, and the remaining ingredients are added in additional increments. In other embodiments, part of the rubber can be added on top of the other ingredients. In one or more embodiments, two-stage mixing can be employed.

The renewable filler can be added with the rubber near the beginning of the mixing cycle. (e.g., in the masterbatch). In one or more embodiments, the renewable filler is added before the cure package is added. In other embodiments, it can be added with the cure package during final mix.

When utilizing an internal mixer, the dry or powdery materials such as the carbon black can be added first, followed by the processing aids and finally the rubber to form the masterbatch. The cure package (sulfur, accelerants, antidegredants, etc.) can be added near the end of the mixing cycle and at lower temperatures to prevent premature crosslinking of the rubber. In other embodiments, the cure package can be added to the masterbatch in order to improve dispersion.

In one or more embodiments, the vulcanizable elastomer is provided or introduced to the other ingredients in the form of a latex (or at least a portion of the elastomer is added as a latex). It is believed that by introducing the elastomer as a latex, the tack of the vulcanizable composition can be increased thereby facilitating processing of the composition. For example, in one or more embodiments, a natural rubber latex, a nitrile rubber latex, and/or a polychloroprene latex may be introduced with the other ingredients and mixed by conventional techniques including the use of an internal mixer.

Once mixed, the rubber composition can be then formed into a sheet via calendaring or combined with a reinforcing cord-(fabric or metal). The compositions of the invention can also be formed into various types of articles using other techniques such as extrusion.

The vulcanizable rubber compositions of the present invention can be formed into airsleeves of air springs by employing conventional techniques for fabricating and manufacturing air springs. Air spring and air sleeve constructions and methods of their manufacture are known in the art as exemplified in U.S. Pat. Nos. 7,250,203, 5,527,170, and 6,439,550, which are incorporated herein by reference.

Various modifications and alterations that do not depart from the scope and spirit of this invention will become apparent to those skilled in the art. This invention is not to be duly limited to the illustrative embodiments set forth herein.

1. An air spring having an airsleeve having a plurality of layers, where at least one layer of said airsleeve includes a rubber component that comprises ground corn filler having an average particle size of less than 10 microns.

2-3. (canceled)

4. The air spring of claim 5, where the ground corn filler has an average particle size of less than 5 microns.

5. The air spring of claim 1, where the rubber component includes from about 10 to about 50 pbw phr ground corn filler.

6. The air spring of claim 1, where the airsleeve includes an inner layer, an outer layer, and at least one reinforcing layer, and where the rubber component of the inner layer, the outer layer, and the at least one reinforcing layer is the same.

7. An air spring having an airsleeve, the airsleeve comprising an outer layer, an inner layer, and at least one reinforcing layer, where said outer layer, inner layer, and reinforcing layer each independently include a rubber component, where at least one of said layers of said airsleeve includes a rubber component that is the vulcanization product of a vulcanizable composition comprising:
an elastomer selected from the group consisting of natural rubber, synthetic polyisoprene, polybutadiene, polyisobutylene-co-isoprene, polychloroprene, poly(ethylene-co-propylene), poly(styrene-co-butadiene), poly(styrene-co-isoprene), poly(styrene-co-isoprene-co-butadiene), poly(isoprene-co-butadiene), poly(ethylene-co-propylene-co-diene), polysulfide rubber, acrylic rubber, urethane rubber, nitrile rubber, hydrogenated nitrile rubber, silicone rubber, epichlorohydrin rubber, chlorinated polyethylene and mixtures thereof;
from about 10 to about 50 pbw phr of a ground corn filler having an average particle size of less than 10 microns; and
a sulfur-based curative.

8-9. (canceled)

10. The air spring of claim 7, where the ground corn filler has an average particle size of less than 5 microns.

11-13. (canceled)

14. An air spring airsleeve comprising an outer layer, an inner layer, and at least one reinforcing layer, where said outer layer comprises a rubber component that is the vulcanization product of a vulcanizable composition comprising:
a vulcanizable elastomer;
a ground corn non-black filler having an average particle size of less than 10 microns;
a colorant; and
a curative, where the outer layer is non-black.

15. (canceled)

16. The air spring airsleeve of claim 14, where the vulcanizable composition includes from about 10 to about 50 pbw phr ground corn filler.

17. The air spring airsleeve of claim 14, where the elastomer includes natural rubber, synthetic polyisoprene, polybutadiene, polyisobutylene-co-isoprene, polychloroprene, poly(ethylene-co-propylene), poly(styrene-co-butadiene), poly(styrene-co-isoprene), poly(styrene-co-isoprene-co-butadiene), poly(isoprene-co-butadiene), poly(ethylene-co-propylene-co-diene), polysulfide rubber, acrylic rubber, urethane rubber, nitrile rubber, hydrogenated nitrile rubber, silicone rubber, epichlorohydrin rubber, chlorinated polyethylene or a mixture thereof.

18. The air spring of claim 4, where the airsleeve comprises an outer layer, an inner layer, and at least one reinforcing layer, and where the rubber component of the inner layer, the outer layer, and the at least one reinforcing layer is the same.

19. The air spring airsleeve of claim 14, where the ground corn filler has an average particle size of less than 5 microns.

20. The air spring of claim 7, where the vulcanizable composition comprises polyisobutylene-co-isoprene.

21. The air spring of claim 7, where the vulcanizable composition includes less than 40 pbw phr ground corn filler.

22. The air spring of claim 20, where the rubber component of the inner layer, the outer layer, and the at least one reinforcing layer is the same.

23. The air spring of claim 7, where said at least one layer is said outer layer.

24. The air spring airsleeve of claim 14, where the vulcanizable composition comprises polyisobutylene-co-isoprene.

25. The air spring airsleeve of claim 16, where the elastomer includes natural rubber, synthetic polyisoprene, polybutadiene, polyisobutylene-co-isoprene, polychloroprene, polyethylene-co-propylene), polystyrene-co-butadiene), poly(styrene-co-isoprene), poly(styrene-co-isoprene-co-butadiene), poly(isoprene-co-butadiene), poly(ethylene-co-propylene-co-diene), polysulfide rubber, acrylic rubber, urethane rubber, nitrile rubber, hydrogenated nitrile rubber, silicone rubber, epichlorohydrin rubber, chlorinated polyethylene or a mixture thereof.

26. The air spring airsleeve of claim 25, where the rubber component of the inner layer, the outer layer, and the at least one reinforcing layer is the same.

27. The air spring airsleeve of claim 26, where the vulcanizable composition comprises polyisobutylene-co-isoprene.

28. The air spring airsleeve of claim 27, where the curative includes a sulfur-based compound.
